(19) United States
(12) Patent Application Publication
(10) Pub. No.: US 2024/0045068 A1
(43) Pub. Date: Feb. 8, 2024

(54) LiDAR SYSTEM AND RESOLUSION IMPROVEMENT METHOD THEREOF

(71) Applicant: Guangzhou Tyrafos Semiconductor Technologies Co., Ltd., Guangzhou (CN)

(72) Inventors: Jun-Wen Chung, Tainan City (TW); Hsu-Wen Fu, Kaohsiung City (TW); Ping-Hung Yin, Hsinchu City (TW)

(21) Appl. No.: 18/230,334

(22) Filed: Aug. 4, 2023

Related U.S. Application Data
(60) Provisional application No. 63/395,347, filed on Aug. 5, 2022.

(30) Foreign Application Priority Data
May 8, 2023 (TW) 112117055

(51) Int. Cl. G01S 17/894; G01S 7/4863; G01S 7/481; G01S 7/484

(52) U.S. Cl. CPC G01S 17/894; G01S 7/4863; G01S 7/4818; G01S 7/4816; G01S 7/484

(57) ABSTRACT

A LiDAR system includes a microcontroller, a laser light source, a lens module, and a receiver. The lens module includes a receiver lens module and a laser beam splitter module. The laser beam splitter module includes a diffractive optical element and a collimation lens assembly. The laser light source emits a plurality of laser beams with different wavelengths and includes a light coupler. The light coupler optically couples the laser beams into a collimated light signal. In a sensor shutter time of each subframe in a frame, a plurality of pixels of the receiver receive at least one reflective light signal of the laser light with different wavelengths to obtain a plurality of subframes of environmental images, and takes a distance value represented by the reflective light signals as a distance value of the pixels of the subframe, the microcontroller fuses the distance values of the pixels of the plurality of subframes of the environmental images as a final distance value of the frame.

### CROSS-REFERENCE TO RELATED APPLICATION

This application claims the priorities of U.S. provisional application No. 63/395,347, filed on Aug. 5, 2022; and Taiwanese patent application No. 112117055, filed on May 8, 2023, the content of which are incorporated herewith by reference.

### BACKGROUND OF THE INVENTION

### 1. Field of the Invention

The present invention relates generally to a LiDAR system, and more particularly, to a LiDAR system with an improved resolution.

### 2. The Prior Arts

In recent years, light detection and ranging (LiDAR) technologies are widely applied in vehicle auto/semi-auto driving and safety alerts. The LiDAR mainly include a sensor (such as a direct time of flight (D-ToF) sensor), a laser light source, a scanner, and a data processor. The current LiDAR scanning methods include a variety of forms, such as projecting small-area light dots with an optical phased array (OPA) or diffractive optical element (DOE), scanning a large area in a zigzag shape or diagonal shape with a microelectromechanical system (MEMS) micro-galvanometer scanner or polygon mirror, or projecting linear light beams and horizontally scanning a large area through mechanical rotation with a DOE, multiple-point linear light source or multiple reflection and beam expansion, and so on. With the aforementioned scanning methods, the sensor may receive the reflected light signals.

However, the laser light source detection with the aforementioned methods has smaller screen ratio, so the receiving of the reflected light signals is required to be persistently performed in higher frequencies. By contrast, by projecting a large area of light dots simultaneously, a flash LiDAR may achieve high-frequency and high-frame sensing with relative low system computational demand and total energy consumption. It is also desirable if the image resolution of the flash LiDAR may further increase with fixed light dot density, which may make the image clearer, increase the accuracy of distance measurement, and further increase driving safety. As such, a LiDAR system with increased resolution compared to the prior art with the same light dot density is desired to be provided to correctly determine the distances and ensure driving safety. A resolution improvement method is desired to be provided as well to increase the resolution of a LiDAR system compared to the prior art with the same light dot density to correctly determine the distances and ensure driving safety.

### SUMMARY OF THE INVENTION

A primary objective of the present invention is to provide a LiDAR system with an increased resolution compared to the prior art with the same light dot density to correctly determine the distances and ensure driving safety.

For achieving the foregoing objectives, the present invention provides a LiDAR system. The LiDAR system includes a microcontroller unit, a laser light source coupled to the microcontroller unit, a lens module, and a receiver coupled to the microcontroller unit. The laser light source emits a plurality of laser lights with different wavelengths and includes a light coupler and a fiber, the light coupler optically coupling the laser lights into a collimated light signal transmitted through the fiber. The lens module includes a laser beam splitter module and a receiver lens module, the laser beam splitter module receives the laser lights emitted from the laser light source and diffracts the laser lights into a plurality of diffractive lights, the diffractive lights being emitted towards a target. The laser beam splitter module includes a diffractive optical element and a collimation lens assembly. The receiver lens module receives a reflective light signal of the diffractive lights reflected from the target and emits the reflective light signal towards the receiver. The laser light source emits a pulse signal with a cycle time. The microcontroller controls the receiver to turn on during a sensor shutter time and turn off during a reset time in each cycle time. In a sensor shutter time of a subframe in a frame, a plurality of pixels of the receiver receive at least one reflective light signal of the laser lights with different wavelengths, obtains environmental images of a plurality of subframes, and takes distance values representing the reflective light signals as the distance values of the pixels in the subframe. The microcontroller unit fuses the distance values of the pixels in the environmental images of the plurality of subframes as a final distance value of the frame.

For achieving the foregoing objectives, the present invention provides a resolution improvement method of the LiDAR system. The method includes: setting the diffractive optical element as a movable element with a function of rotation and/or reciprocating movement; under conditions of a plurality of rotation angles or displacement positions, obtaining a plurality of subframes of environmental images; the reflective light signals at each pixel of the environmental images representing a sub-distance value, a plurality of sub-distance values in each environmental image of a subframe constituting a three-dimensional image with depth information; and after eliminating abnormal subframes, fusing the environmental images of the remaining subframes, if a pixel has a plurality of sub-distance values, taking an average or selecting one, if the pixel has only one sub-distance value, selecting the sub-distance value, if the pixel has no sub-distance value, selecting a maximum value within a detection range, and calculating the final distance value of the three-dimensional image of the frame.

Accordingly, the advantageous effect of the present invention is: with fixed light dot density, further increasing the image resolution of a flash LiDAR to make the image clearer, increase the accuracy of distance measurement, and further increase driving safety.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a LiDAR system of the present invention;

FIGS. 2A and 2B are schematic diagrams of the interior structures of a part of elements shown in FIG. 1;

FIGS. 2C and 2D are schematic diagrams of a single-slit diffraction;

FIG. 2E shows an overlap among point clouds created by laser lights with different wavelengths;

FIGS. 3A and 3B show an operation of a diffractive optical element;

FIG. 4 shows an operation of the present invention at different distances;

FIG. 5A is an arrangement of a collimation lens assembly according to the present invention;

FIG. 5B is another arrangement of a collimation lens assembly according to the present invention;

FIG. 6 is an exemplified timing diagram according to the present invention;

FIG. 7 is another exemplified timing diagram according to the present invention;

FIG. 8 is a flow chart of a resolution improvement method according to the present invention;

FIGS. 9A, 9B and 9C are exemplified timing diagrams of the present invention;

FIG. 10A is a real environmental image;

FIGS. 10B, 10C and 10D are sampling examples of FIG. 10A; and

FIGS. 11A, 11B, 11C, 11D, 11E and 11F are sampling patterns of different subframes within a frame.

### DETAILED DESCRIPTION OF THE PREFERRED EMBODIMENT

The accompanying drawings are included to provide a further understanding of the invention and are incorporated in and constitute a part of this specification. The drawings illustrate embodiments of the invention and, together with the description, serve to explain the principles of the invention.

The present invention provides a LiDAR system with an improved resolution and a resolution improvement method of the LiDAR system. By projecting laser lights with a plurality of wavelengths and the rotation or oscillation of the diffractive optical element, the image resolution may be increased under fixed light dot density.

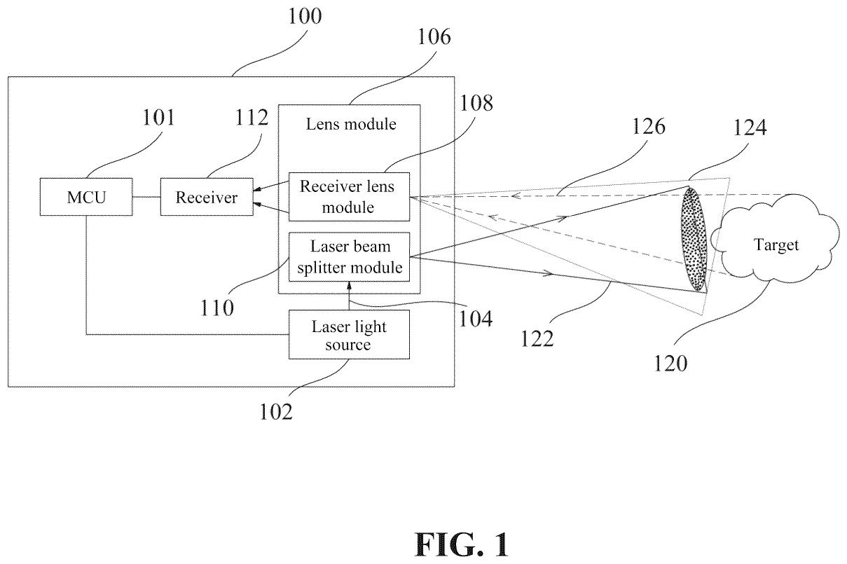

Referring to FIG. 1, the present invention provides a LiDAR system 100, including a microcontroller unit (MCU) 101, a laser light source 102, a lens module 106 and a receiver 112. The lens module 106 includes a receiver lens module 108 and a laser beam splitter module 110. The laser light source 102 and the receiver 112 are coupled to the MCU 101.

To measure the distance between a target 120 and the LiDAR system 100, first, the MCU 101 controls the laser light source 102 to emit a laser light 104. Then, the laser beam splitter module 110 scatters the laser light 104 into a plurality of light dots, the light dots distribute within a field of image (FOI) 122, and the FOI 122 completely covers the target 120. Subsequently, after touching the target 120, the light dots are reflected as a plurality of reflective lights 126, the reflective lights 126 distributing within a field of view (FOV) 124. The receiver lens module 108 receives reflective lights 126 and sends reflective light signals to the receiver 112. The receiver 112 sends the received signals to the MCU 101 for subsequent image analyses.

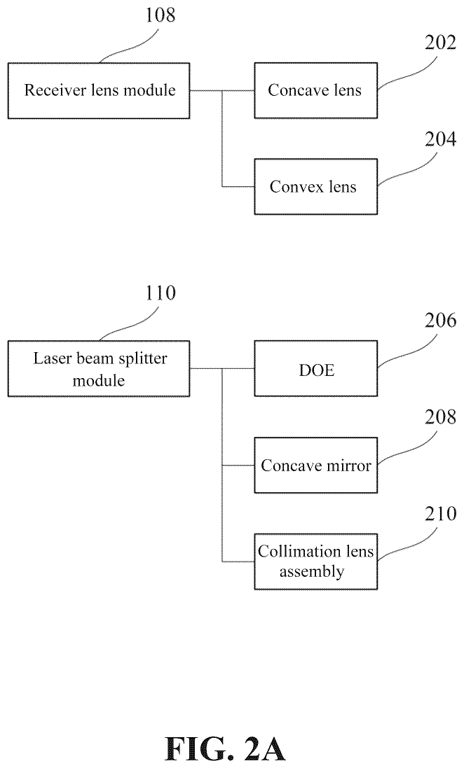

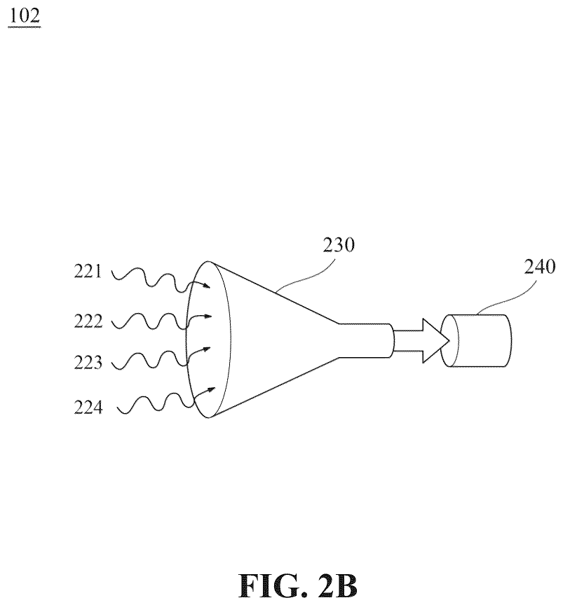

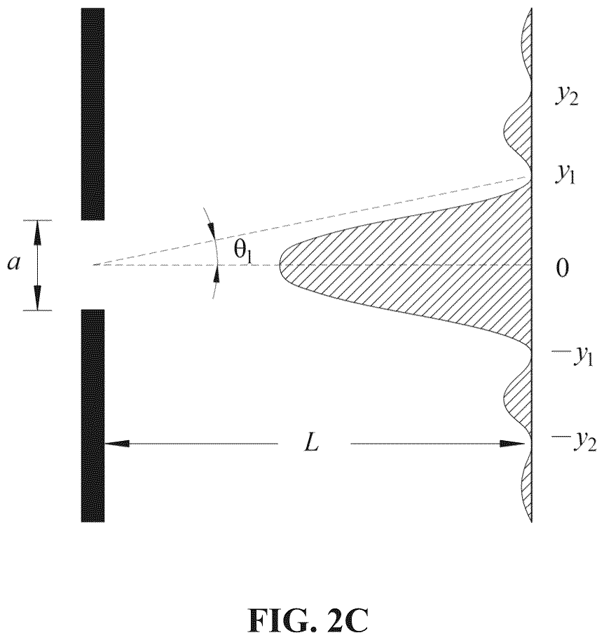

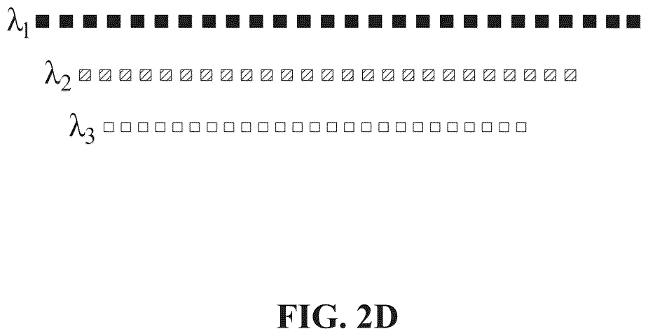

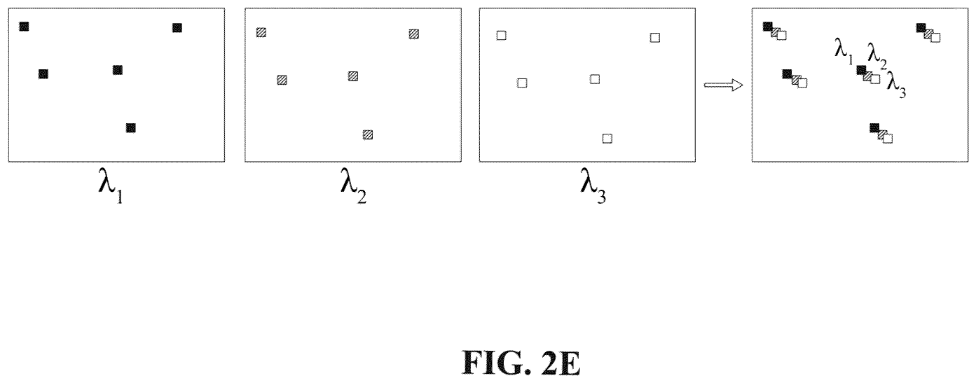

Referring to FIG. 2A, the receiver lens module 108 in FIG. 1 includes a lens module comprising at least one concave lens 202 and at least one convex lens 204. The concave lens 202 and the convex lens 204 form a condensing lens module which may condense the reflective lights 126 in FIG. 1 to send light signals to the receiver 112. The laser beam splitter module 110 in FIG. 1 includes a diffractive optical element (DOE) 206, a concave mirror 208 and a collimation lens assembly 210, in which the DOE 206 has a function of rotation or oscillation. The operation of the laser beam splitter module 110 will be explained in detail below.

Referring to FIG. 2B, the laser light source 102 in FIG. 1 may emit a plurality of (for example, but not limited to, four) laser lights 221, 222, 223 and 224 with different wavelengths, the laser light source 102 including a light coupler 230 and a fiber 240. The laser lights 221, 222, 223 and 224 may be, for example, infrared lights with wavelengths, for example, 850 nm, 905 nm, 940 nm and 1064 nm. The laser lights 221, 222, 223 and 224 may be emitted simultaneously or sequentially. The light coupler 230 optically couples the laser lights 221, 222, 223 and 224 into a single collimated light signal transferred towards the lens module through the fiber 240.

According to the principle of single-slit diffraction, the diffractive angle θₙ is associated with the slit width a and the wavelength λ:

a sin θₙ=nλ, n=±1,±2,±3 . . .

Referring to FIG. 2C, when the projection distance L is fixed, the minimum light intensity positions y₁, y₂, . . . and −y₁, −y₂, . . . are associated with the diffractive angle θₙ. When the wavelength λ is within the range of infrared light (approximately at the scale of 1000 nm) and the slit width a is at the scale of mm, the diffractive angle θₙ is extremely small, where:

sin θₙ≈tan θₙ≈θₙ=nλ/a

and the minimum light intensity positions yₙ are:

yₙ=L tan θₙ=Lnλ/a

As such, by emitting laser lights with different wavelengths λ, point clouds with different gap sizes may be created. As shown in FIG. 2D, the point clouds created by laser lights with wavelengths λ₁, λ₂ and λ₃ have different diffractive point intervals, thus when the laser lights with wavelengths λ₁, λ₂ and λ₃ are optically coupled as a single light signal and emitted, the single-slit diffraction patterns created by laser lights with wavelengths λ₁, λ₂ and λ₃ have different diffractive point intervals, and these single-slit diffraction patterns may fill the gaps of each other, effectively increasing point cloud density, and further increasing the image resolution. As shown in FIG. 2E, the point clouds created by the laser lights with wavelengths λ₁, λ₂ and λ₃ fall at different positions. When the laser lights with wavelengths λ₁, λ₂ and λ₃ are optically coupled as a single light signal and emitted, the point clouds may overlap with each other, effectively increasing point cloud density, and further increasing the image resolution. Such a method is suitable for dynamic detection situations.

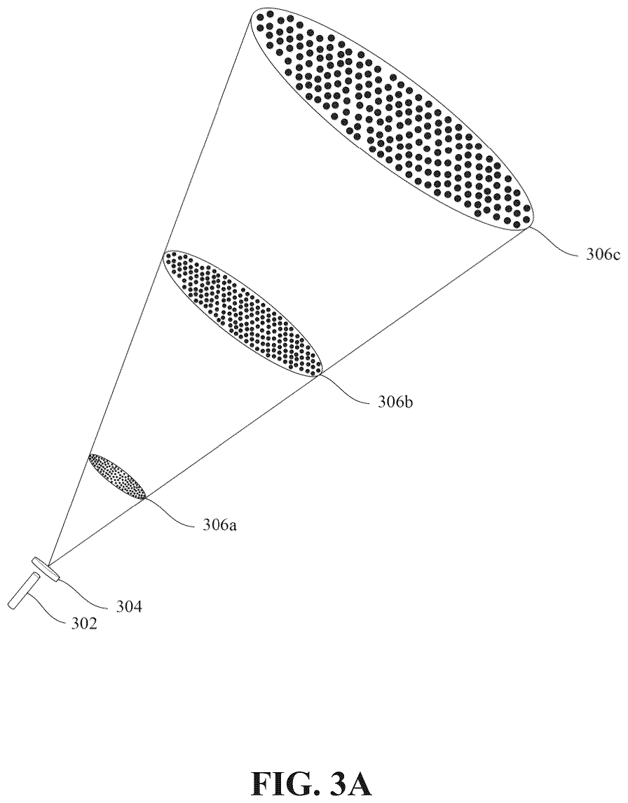

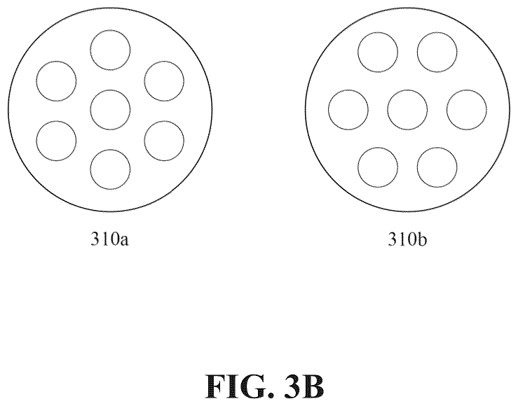

Referring to FIG. 3A, when a laser light 302 is emitted towards a DOE 304, the DOE 304 diffracts the laser light 302 into thousands to tens of thousands of light dots. The light dots form point clouds 306a, 306b and 306c at different distances, in which the point cloud 306a is the nearest to the DOE 304, the light dots are the most dense, and the covering area of the point cloud is the smallest; the point cloud 306c is the farthest to the DOE 304, the light dots are the least dense, and the covering area of the point cloud is the largest. The DOE 304 may be, for example, a HCPDOE™ of Guangzhou Tyrafos Semiconductor Technologies Co., Ltd., but the invention is not limited thereto.

Referring to FIG. 3B, by rotation or oscillation, DOEs 310a and 310b may be two patterns of the DOE 304 at different time intervals. It may be understood from FIG. 3B that through the rotation and/or reciprocating movement of the DOEs 310a and 310b, the light dot positions of the DOE 310b may cover the gaps between the light dots of the DOE 310a, and vice versa. Thus, in each of a plurality of subframes in a frame, the projected positions of the light dots of the DOE 304 may change. By fusing a plurality of subframes, the light dot emitting area may be increased and the image resolution may be improved without increasing light dot density. Such a method is suitable for static detection situations.

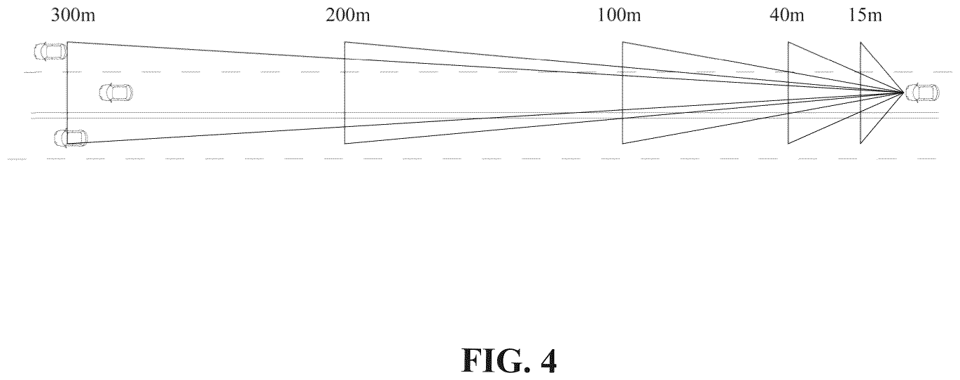

Due to the point cloud covering areas shown in FIG. 3A being proportional to the square of distances, the point cloud covering area will rapidly expand when the distance is relatively long, causing the decrease of light energy per unit area and the insufficiency of reflective light intensity. However, significantly increasing the intensity of the laser light 302 may decrease the lifetime of equipment and is hazardous to human eyes. Thus, referring to FIG. 4, a lens module with an adjustable focal length comprising at least a concave lens 202 and at least a convex lens 204 may adjust the size of the FOV according to a detection range, so that the light energy per unit area is substantially equal at different distances (for example, 15 m, 40 m, 100 m, 200 m and 300 m) to prevent from the insufficiency of reflective light intensity at longer distances. Alternatively, a plurality of lens modules of fixed focal lengths, each of the lens modules including at least one concave lens 202 and at least one convex lens 204 with the lens modules being switched according to a detection range, may be used to modulate the size of the FOV.

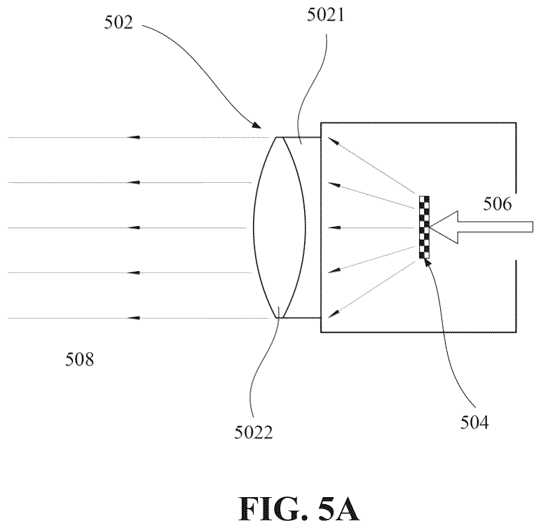

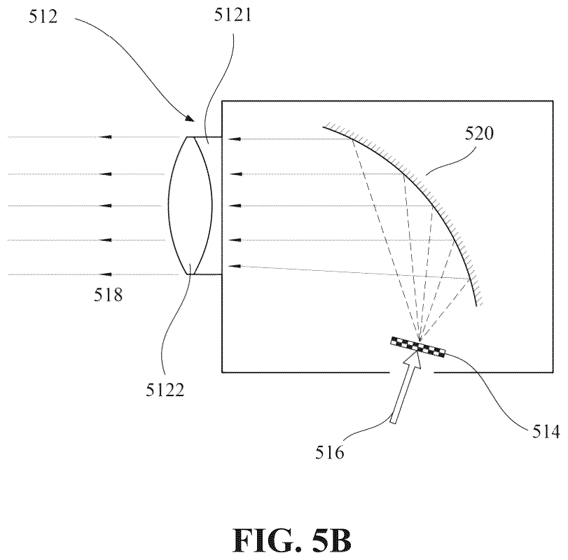

A way to achieve the arrangement shown in FIG. 4 is using a collimation lens assembly to converge the covering area of diffractive lights within a range. By the modulation of focal lengths, the collimation lens assembly may modulate the divergence angle of the emitted parallel light and adjust the range of FOI of the projected light dots according to the detection range to achieve the effect shown in FIG. 4. A plurality of collimation lens assemblies with fixed focal lengths with the collimation lens assemblies being switched according to the detection range may be used to modulate the range of FOI. Alternatively, a collimation lens assembly with an adjustable focal length with the collimation lens assembly being switched according to the detection range may be used to modulate the range of FOI. Referring to FIG. 5A, an arrangement of collimation lens assembly is placing a collimation lens assembly 502 in front of a DOE 504 capable of rotating or oscillating, where the mirror surface of the collimation lens assembly 502 is perpendicular to the incident direction of a laser light 506. As shown in FIG. 5A, the collimation lens assembly 502 may converge diffractive lights 508 emitted from the DOE 504 to be substantially parallel to each other, so that the light energy per unit area of the diffractive lights 508 remains substantially equal at different distances. In an embodiment, the collimation lens assembly 502 includes a concave lens 5021 and a convex lens 5022, in which the distance between the concave lens 5021 and the convex lens 5022 is adjustable to control the divergence angle.

Referring to FIG. 5B, another collimation lens assembly arrangement is placing a collimation lens assembly 512 in front of a concave mirror 520 and collecting the diffractive lights emitted from a DOE 514 capable of rotating or oscillating with the concave lens 520. As shown in FIG. 5B, the DOE 514 diffracts a laser light 516 into a plurality of diffractive lights 518, the diffractive lights 518 being reflected and converged for the first time by the concave mirror 520 and emitted towards the collimation lens assembly 512. Subsequently, the collimation lens assembly 512 converges the diffractive lights 518 for the second time to be substantially parallel to each other, so that the light energy per unit area of the diffractive lights 518 remains substantially equal at different distances. In an embodiment, the collimation lens assembly 512 includes a concave lens 5121 and a convex lens 5122, in which the distance between the concave lens 5121 and the convex lens 5122 is adjustable to control the divergence angle. Compared with the arrangement shown in FIG. 5A, such an arrangement may collect diffractive lights within a greater angle, which increases the emitted light energy per unit area without increasing the intensity of the laser light.

In the practical situation of vehicle auto-driving, when a vehicle is moving, the crosstalk the LiDAR system 100 may receive includes the scanning laser of front vehicles at the opposite lane, the front-orientation pulse laser of front vehicles at the opposite lane, the scanning laser of front vehicles at the same direction lane, the rear-orientation pulse laser of front vehicles at the same direction lane, and so on. Thus, it is desired to eliminate the crosstalk to correctly measure distances and ensure driving safety.

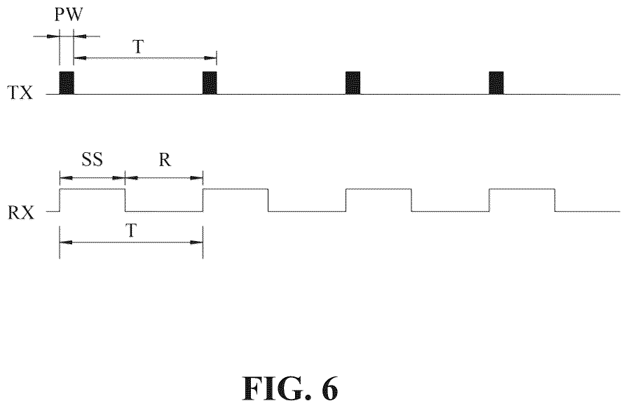

When the laser light source 102 in FIG. 1 emits a pulse signal, to eliminate crosstalk, the MCU 101 may turn on or off the receiver 112 according to the detection range, so that the receiver 112 receives only the reflective light signals within the detection range. For example, if the object to measure is 300 meters away, the required time from the laser light source 102 emitting a pulse signal to the receiver 112 receiving a reflective light signal is 2 μs (R=ct/2, where R is the distance, c is the speed of light 3×10⁸ m/s, t is the time (sec)). Thus, in a cycle time, the receiver 112 and the laser light source 102 may be synchronously turned on with a sensing time 2 μs and turned off at the remaining time to prevent from receiving crosstalk. Referring to FIG. 6, the laser light source (TX) emits a pulse signal with pulse width PW in a cycle time T. The receiver (RX) is turned on during a sensor shutter time SS and turned off during a reset time R in the cycle time T, where T=SS+R. The sensor shutter time and the reset time R are determined according to the detection range. In an embodiment, when the detection range is 300 m, the sensor shutter time SS is 2 μs, the reset time R is 2 μs, the cycle time T is 4 μs, and the pulse width PW is 100 ns. In this case, the receiver (RX) may receive reflective light signals from 0 to 300 meters away, and the theoretical frame rate (the number of scanning) may be as high as 1/T=2.5×10⁵ f/s.

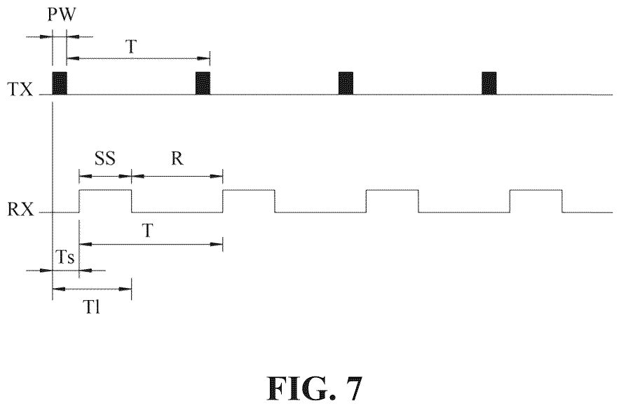

Referring to FIG. 7, in addition to the upper limit of the detection range, the lower limit of the detection range may be set to the receiver (RX) by adjusting the sensor shutter time SS. In FIG. 7, the start time Ts of the sensor shutter time SS is determined according to the lower limit of the detection range, and the end time Tl of the sensor shutter time SS is determined according to the upper limit of the detection range. In an embodiment, when the detection is from 90 to 300 meters, the start time Ts is 600 ns, the end time Tl is 2 μs, the sensor shutter time SS is 1400 ns, the reset time R is 2 μs, the cycle time T is 4 μs, and the pulse width PW is 100 ns. In this case, the receiver (RX) may receive reflective light signals from 90 to 300 meters away, and the theoretical frame rate is 1/T=2.5×10⁵ f/s.

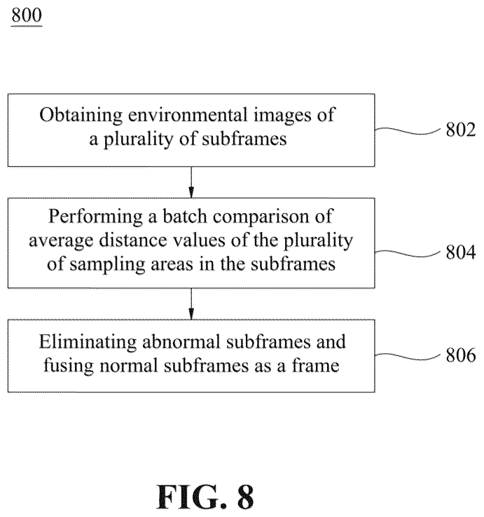

Referring to FIG. 8, in a plurality of (at least three, such as six) subframes of environmental images in a frame, by obtaining a plurality of subframes of environmental images, a method 800 compares average distances of a plurality of sampling areas of each subframe and, with the MCU, fuses the distance values of the pixels in the plurality of subframes of environmental images as a final distance value of the frame. In step 802, the laser light source sequentially emits a plurality of laser light signals to obtain a plurality of subframes of environmental images, in which within a sensor shutter time of a subframe of a frame, the receiver receives at least one reflective light signal of the laser lights with different wavelengths at a plurality of pixels. In each subframe, the plurality of laser lights with different wavelengths may be emitted simultaneously and coupled as a single light signal or may be emitted sequentially. In step 804, take the distance values representing the reflective light signals (the distance values may be calculated according to times of flight (ToF) of the reflective light signals) as the distance values of the pixels in the subframe. In the environmental image including a plurality of sampling areas, perform a batch comparison of the average distance values of the plurality of sampling areas in the subframes (see Tables 2, 3 and 4 below). In step 806, according to the result of the batch comparison in step 804, the MCU eliminates abnormal subframes and fuses normal subframes as a final distance value of the frame. Here, the fusing may be performed by averaging, superposition, selection, or other methods.

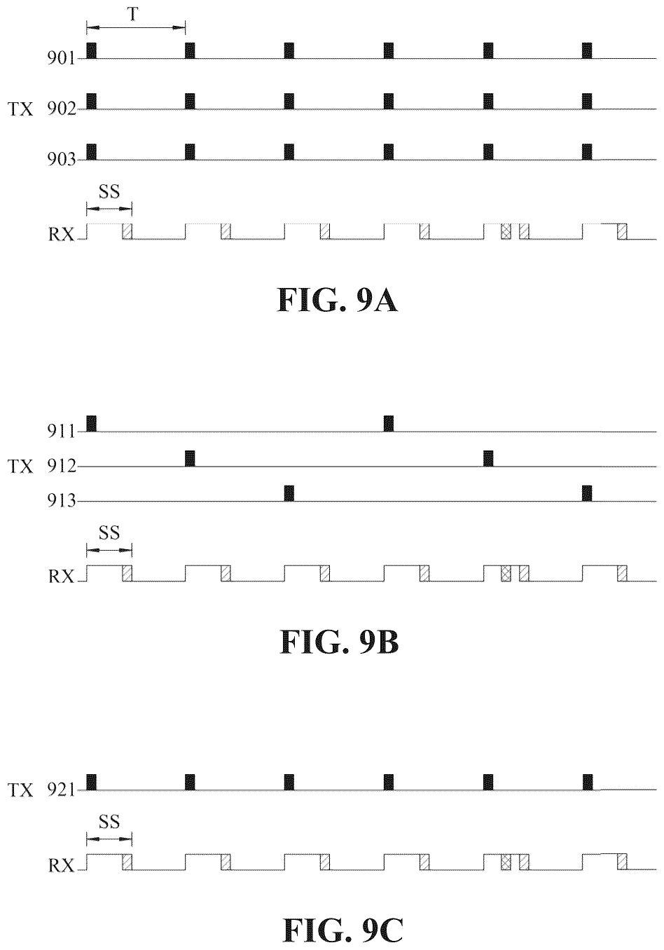

Referring to FIGS. 9A and 9B, as described above, in a dynamic detection situation, the laser lights with different wavelengths may be emitted simultaneously or sequentially. FIG. 9A shows the situation in which the laser lights with different wavelengths are emitted simultaneously. In an example of a frame including six subframes, in each subframe, the laser light source (TX) simultaneously emits laser lights 901, 902 and 903 with different wavelengths in a cycle time T, and the receiver (RX) is turned on during the sensor shutter time SS, receives the reflective light signals of the laser lights 901, 902 and 903, and sends the reflective light signals to the MCU to calculate the sub-distance values after fusing. In the example shown in FIG. 9A, the reflective light signal of the fifth subframe falls at a position distinct from other subframes in the sensor shutter time SS, thus the MCU may eliminate the sub-distance value of the fifth subframe and fuse the sub-distance values of the remaining subframes as the final distance value of the frame. FIG. 9B shows the situation in which the laser lights with different wavelengths are emitted sequentially. In an example of a frame including six subframes, in each subframe, the laser light source (TX) sequentially emits laser lights 911, 912 and 913 with different wavelengths in a cycle time T, and the receiver (RX) is turned on during the sensor shutter time SS, receives the reflective light signals of the laser lights 911, 912 and 913, and sends the reflective light signals to the MCU to calculate the sub-distance values representing the reflective light signals. In the first subframe, the laser light 911 is emitted. In the second subframe, the laser light 912 is emitted. In the third subframe, the laser light 913 is emitted. In the fourth subframe, the laser light 911 is emitted. In the fifth subframe, the laser light 912 is emitted. In the sixth subframe, the laser light 913 is emitted. As such, the MCU may calculate the sub-distance values of each subframe, in which the first subframe and the fourth subframe are associated with the laser light 911, the second subframe and the fifth subframe are associated with the laser light 912, and the third subframe and the sixth subframe are associated with the laser light 913. In the example shown in FIG. 9B, the reflective light signal of the fifth subframe falls at a position distinct from other subframes in the sensor shutter time SS (that is, the time of flight is distinct), thus the average distance value of the fifth subframe is distinct from the remaining subframes. Hence, the MCU may eliminate the sub-distance value of the fifth subframe and fuse the sub-distance values of the remaining subframes as the final distance value of the frame.

Referring to FIG. 9C, as described above, in a static detection situation, by rotation or oscillation, in each of a plurality of subframes in a frame, by setting the DOE 304 as a movable element with a function of rotation and/or reciprocating movement, the projected positions of the light dots of the DOE 304 may change. In FIG. 9C, under conditions of a plurality of rotation angles or displacement positions, obtain a plurality of subframes of environmental images, and the projected positions of the light dots of laser light 921 may change in each subframe. Each of the reflective light signals at each pixel of the environmental images represents a sub-distance value, and a three-dimensional image with depth information is formed with a plurality of sub-distance values in each environmental image of a subframe. Subsequently, after eliminating abnormal subframes, the MCU fuses the environmental images of the remaining subframes. If a pixel has a plurality of sub-distance values, take an average or select one. If the pixel has only one sub-distance value, select the sub-distance value. If the pixel has no sub-distance value, select the maximum value within a detection range. Finally, calculate the final distance value of the three-dimensional image of the frame. For example, in an embodiment, Tables 1A to 1F below represent an identical sampling area at the first subframe to the sixth subframe of a frame respectively, in which a small box represents a pixel, the numbers in the boxes represent the sub-distance values obtained at the pixels of the subframe, and the unnumbered boxes represent the pixels without sub-distance values. For each subframe, obtain an average distance value of the pixels with sub-distance values, and eliminate the abnormal subframes according to the average distance values of each subframe. It can be understood from Tables 1A to 1F that the average distance value of the sixth subframe is significantly distinct from the remaining subframes, thus the sixth subframe is regarded as an abnormal subframe and eliminated. Subsequently, as shown in Table 1G, superpose each pixel of the normal subframes (the first subframe to the fifth subframe, corresponding to Tables 1A to 1E) and obtain an average value of the pixels with sub-distance values after superposition as the final distance value of the sampling area at the frame. When superposing, if there are a plurality of sub-distance values at a pixel, take the average value or select the maximum value. If the pixel has no sub-distance value, select the minimum value within the detection range (for example, 0). Alternatively, if there are a plurality of sub-distance values at a pixel, take the average value or select the minimum value. If the pixel has no sub-distance value, select the maximum value within the detection range (for example, 500 or 1000). In the example shown in FIG. 9C, the sub-distance value of the fifth subframe is distinct from the remaining subframes, thus the MCU may eliminate the sub-distance value of the fifth subframe and fuse the remaining subframes to calculate the final distance value of the frame.

TABLE 1A
(first subframe, average 150.32)

| | | | | |
|---|---|---|---|---|
| | | | | 150.3 |
| 150.2 | | | | |
| | | 150.4 | | |
| | | | | 150.4 |
| | 150.2 | | | |
| | | | 150.4 | |

TABLE 1B
(second subframe, average 150.26)

| | | | | |
|---|---|---|---|---|
| | | | | 150.2 |
| 150.3 | | | | |
| | | 150.3 | | |
| | 150.3 | | | |
| | | | 150.2 | |

TABLE 1C
(third subframe, average 150.27)

| | | | | | |
|---|---|---|---|---|---|
| 150.1 | | | | 150.3 | |
| | | 150.2 | | | |
| | | | | | 150.4 |
| | 150.2 | | | | |
| | | | 150.4 | | |

TABLE 1D
(fourth subframe, average 150.30)

| | | | | |
|---|---|---|---|---|
| 150.2 | | | | |
| | | | | 150.3 |
| | 150.3 | 150.4 | | |
| 150.2 | | | | |
| | | | 150.4 | |

TABLE 1E
(fifth subframe, average 150.28)

| | | | | |
|---|---|---|---|---|
| | 150.3 | | | |
| | | | 150.3 | |
| 150.2 | | | | |
| | | 150.3 | | |
| 150.2 | | | | 150.4 |

TABLE 1F
(sixth subframe, average 45.55)

| | | | | | | |
|---|---|---|---|---|---|---|
| 45.6 | | | 45.5 | | | |
| | | | | | 45.6 | |
| | 45.6 | | | | | |
| | | | | 45.6 | | 45.5 |
| | | 45.6 | | | | |
| | | | | | 45.5 | |
| | 45.5 | | | | | |
| | | | 45.5 | | | |
| | | | | | | 45.6 |

TABLE 1G
(after eliminating the sixth subframe, superposing all the pixels of
the first to fifth subframes)

| | | | | | | | | | |
|---|---|---|---|---|---|---|---|---|---|
| 0 | 150.2 | 0 | 0 | 0 | 0 | 0 | 0 | 150.3 | 150.2 |
| 0 | 150.2 | 150.3 | 150.3 | 0 | 0 | 0 | 150.3 | 0 | 150.3 |
| 0 | 0 | 0 | 0 | 0 | 0 | 0 | 150.3 | 0 | 0 |
| 0 | 0 | 150.3 | 0 | 150.4 | 0 | 150.4 | 0 | 0 | 0 |
| 0 | 150.2 | 0 | 0 | 0 | 0 | 0 | 0 | 150.4 | 0 |
| 0 | 0 | 0 | 150.3 | 0 | 150.3 | 0 | 0 | 0 | 150.4 |
| 0 | 0 | 150.2 | 0 | 0 | 0 | 0 | 0 | 0 | 0 |
| 0 | 150.2 | 150.2 | 0 | 0 | 0 | 150.4 | 150.2 | 0 | 0 |
| 0 | 150.2 | 0 | 0 | 0 | 0 | 150.4 | 150.4 | 0 | 150.4 |
| 0 | 0 | 0 | 0 | 0 | 0 | 0 | 0 | 0 | 0 |

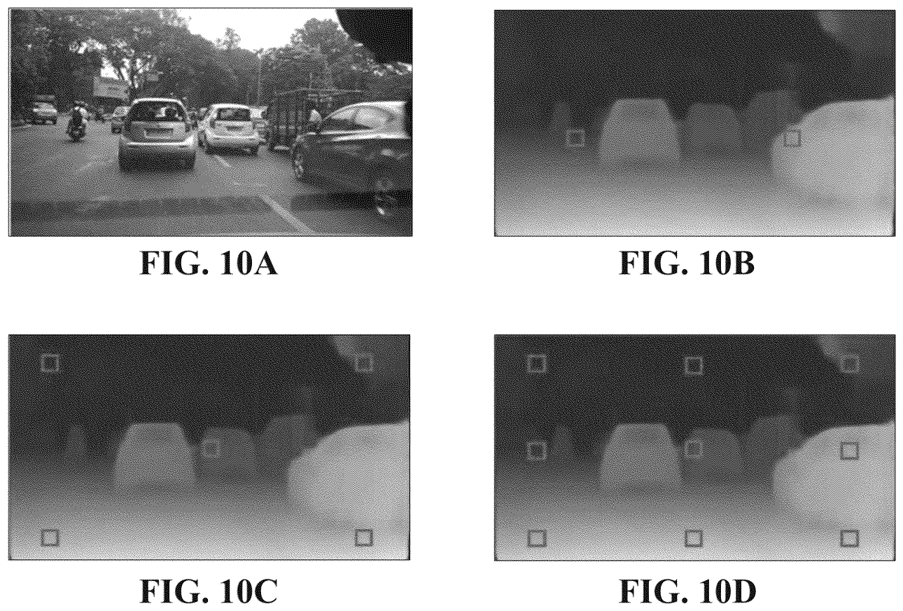

FIG. 10A is a real environmental image. To increase calculating efficiency, it is desirable to sample a plurality of areas to measure instead of measuring the distances of every pixel on the image. Each sampling area includes a plurality of pixels, for example, 10×10 pixels. It is desirable not to sample too many pixels, for example, no more than 10% of the total number of pixels, to increase calculating efficiency. FIG. 10B shows an embodiment of sampling two areas. FIG. 10C shows an embodiment of sampling five areas. FIG. 10D shows an embodiment of sampling nine areas. The number of sampling areas is preferably no less than five to grasp the environmental information effectively. In a normal subframe, the number of sampling areas with normal distance values is greater than a specific proportion of the total number of sampling areas (for example, 80% or 88.9%, where 80% indicates tolerating a sampling area having an abnormal distance value when sampling five areas, and 88.9% indicates tolerating a sampling area having an abnormal distance value when sampling nine areas). Otherwise, the subframe is regarded as an abnormal subframe.

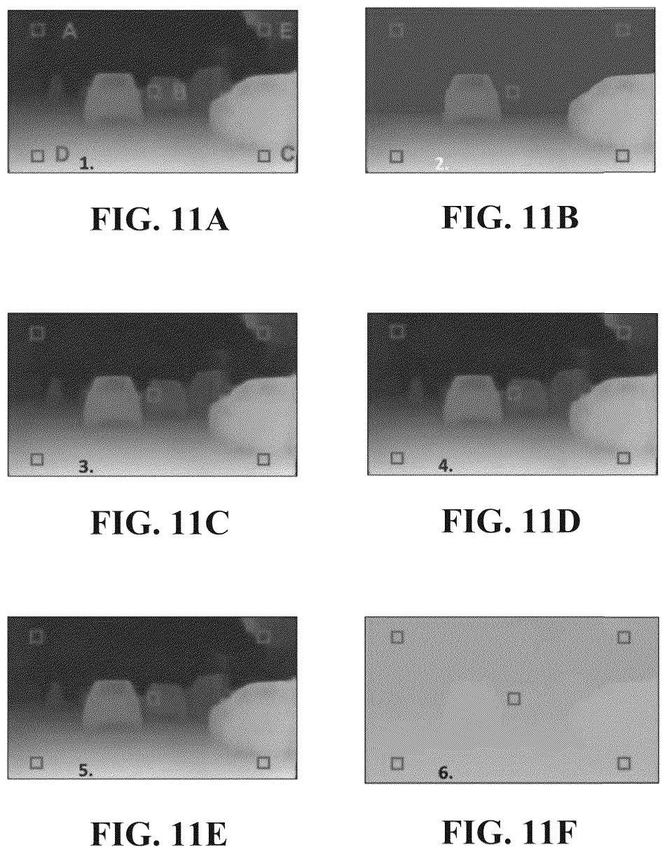

Referring to FIGS. 11A to 11F, in an embodiment of a frame including six subframes, the six subframes are sequentially FIG. 11A, FIG. 11B, FIG. 11C, FIG. 11D, FIG. 11E and FIG. 11F, in which the second subframe (FIG. 11B) and the sixth subframe (FIG. 11F) suffer from the invasion of crosstalk. To effectively eliminate interfered subframes, the distance values measured at the pixels within each sampling area of each subframe may be fused as a sub-distance value of the sampling area at the subframe, and then compare the six sub-distance values of the same sampling area at the six subframes to eliminate abnormal values. In an embodiment, a method of eliminating abnormal values is calculating the average (μ), standard deviation (σ), upper threshold value and lower threshold value of the six sub-distance values of the same sampling area at the six subframes, in which the upper threshold value is the average plus a number of standard deviations (μ+nσ) and the lower threshold value is the average minus a number of standard deviations (μ−nσ), where the value of n is determined according to experimental data and practical needs, and may be an integer or non-integer, such as (but not limited to) 1 or 1.5. In the embodiments shown in Tables 2, 3 and 4 below, the description is taken place with the example of n=1, but the present invention is not limited thereto. Subsequently, eliminate the subframes with sub-distance values greater than the upper threshold value or smaller than the lower threshold value, and fuse the remaining subframes with similar sub-distance values as the final distance value of the frame.

Tables 2, 3 and 4 show possible sensing results. In the example shown in Table 2, at the first subframe, there are no obstacles in front of the sampling area A. Here, the distance of the sampling area A is regarded as the longest distance (for example, 500 m). At the second subframe, there is crosstalk invading the sampling area A. At the sixth frame, sampling areas A, B, C, D and E all suffer from crosstalk invasion. In this case, as shown in Table 2, the distance values of the sampling area A at the second subframe and the sixth subframe are smaller than the lower threshold value, and thus shall be regarded as abnormal values and eliminated. The distance values of the sampling areas B, C, D and E at the sixth subframe are smaller than respective lower threshold values, and thus shall be regarded as abnormal values and eliminated.

TABLE 2

| | Subframe | | | | | | Standard | | Upper | Lower | Abnormal |
|---|---|---|---|---|---|---|---|---|---|---|---|
| Area | 1 | 2 | 3 | 4 | 5 | 6 | deviation | Average | threshold | threshold | subframes |
| A | 500 | 150 | 500 | 500 | 500 | 49 | 191.04 | 366.50 | 557.54 | 175.46 | 2, 6 |
| B | 150 | 150 | 150 | 150 | 150 | 49 | 37.64 | 133.17 | 170.81 | 95.53 | 6 |
| C | 50 | 50 | 50 | 50 | 50 | 49 | 0.37 | 49.83 | 50.21 | 49.46 | 6 |
| D | 50 | 50 | 50 | 50 | 50 | 49 | 0.37 | 49.83 | 50.21 | 49.46 | 6 |
| E | 180 | 150 | 180 | 180 | 180 | 49 | 47.86 | 153.17 | 201.02 | 105.31 | 6 |

In the example shown in Table 3, at the fourth subframe, the sampling area A suffers from crosstalk invasion, and the measured distance value is close to the normal value. At the sixth subframe, sampling areas A, B, C, D and E all suffer from crosstalk invasion. In this case, as shown in Table 3, the distance value of the sampling area A is greater than the upper threshold value at the fourth subframe and smaller than the lower threshold value at the sixth subframe, and thus shall be regarded as abnormal values and eliminated. The distance values of the sampling areas B, C, D and E at the sixth subframe are smaller than respective lower threshold values, and thus shall be regarded as abnormal values and eliminated. As such, although the measured distances of the sampling area A at the fourth subframe and the sixth subframe are close to the normal values, the two subframes may be correctly recognized as abnormal and eliminated.

TABLE 3

| | Subframe | | | | | | Standard | | Upper | Lower | Abnormal |
|---|---|---|---|---|---|---|---|---|---|---|---|
| Area | 1 | 2 | 3 | 4 | 5 | 6 | deviation | Average | threshold | threshold | subframes |
| A | 9.8 | 9.8 | 9.9 | 10 | 9.9 | 9.5 | 0.16 | 9.82 | 9.97 | 9.66 | 4, 6 |
| B | 150 | 150 | 150 | 150 | 150 | 8 | 52.92 | 126.33 | 179.25 | 73.41 | 6 |
| C | 50 | 50 | 50 | 50 | 50 | 8 | 15.65 | 43.00 | 58.65 | 27.35 | 6 |
| D | 50 | 50 | 50 | 50 | 50 | 8 | 15.65 | 43.00 | 58.65 | 27.35 | 6 |
| E | 180 | 150 | 180 | 180 | 180 | 8 | 62.83 | 146.33 | 209.16 | 83.51 | 6 |

In the example shown in Table 4, at the sixth subframe, sampling areas B, C, D and E suffer from crosstalk invasion. In this case, as shown in Table 4, the distance values of the sampling areas B, C, D and E at the sixth subframe are smaller than respective lower threshold values, and thus shall be regarded as abnormal values and eliminated.

TABLE 4

| | Subframe | | | | | | Standard | | Upper | Lower | Abnormal |
|---|---|---|---|---|---|---|---|---|---|---|---|
| Area | 1 | 2 | 3 | 4 | 5 | 6 | deviation | Average | threshold | threshold | subframes |
| A | 9.8 | 9.9 | 9.9 | 9.9 | 9.9 | 9.8 | 0.05 | 9.87 | 9.91 | 9.82 | None |
| B | 150 | 150 | 150 | 150 | 150 | 13 | 51.06 | 127.17 | 178.22 | 76.11 | 6 |
| C | 50 | 50 | 50 | 50 | 50 | 13 | 13.79 | 43.83 | 57.62 | 30.04 | 6 |
| D | 50 | 50 | 50 | 50 | 50 | 13 | 13.79 | 43.83 | 57.62 | 30.04 | 6 |
| E | 180 | 150 | 180 | 180 | 180 | 13 | 60.99 | 147.17 | 208.16 | 86.17 | 6 |

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A LiDAR system, comprising:
a microcontroller unit;
a laser light source, coupled to the microcontroller unit;
a lens module; and
a receiver, coupled to the microcontroller unit,
wherein:
the laser light source emits a plurality of laser lights with different wavelengths and includes a light coupler and a fiber, the light coupler optically coupling the laser lights into a collimated light signal transmitted through the fiber;
the lens module includes a laser beam splitter module and a receiver lens module, the laser beam splitter module receives the laser lights emitted from the laser light source and diffracts the laser lights into a plurality of diffractive lights, the diffractive lights being emitted towards a target;
the laser beam splitter module includes a diffractive optical element and a collimation lens assembly;
the receiver lens module receives a reflective light signal of the diffractive lights reflected from the target, and emits the reflective light signal towards the receiver;
the laser light source emits a pulse signal with a cycle time;
the microcontroller controls the receiver to turn on during a sensor shutter time and turn off during a reset time in each cycle time;
in a sensor shutter time of a subframe in a frame, a plurality of pixels of the receiver receive at least one reflective light signal of the laser lights with different wavelengths, obtains environmental images of a plurality of subframes, and takes distance values representing the reflective light signals as the distance values of the pixels in the subframe; and
the microcontroller unit fuses the distance values of the pixels in the environmental images of the plurality of subframes as a final distance value of the frame.

2. The LiDAR system according to claim 1, further comprising:
in the environmental image including a plurality of sampling areas, performing a batch comparison of average distance values of the plurality of sampling areas in the subframes; and
according to the result of the batch comparison, the microcontroller unit eliminating abnormal subframes and fusing normal subframes as the final distance value of the frame.

3. The LiDAR system according to claim 1, wherein the diffractive optical element has a function of rotation or oscillation.

4. The LiDAR system according to claim 1, wherein the receiver lens module includes a lens module with an adjustable focal length including at least one concave lens and at least one convex lens, which modulates a size of field of view according to a detection range.

5. The LiDAR system according to claim 1, wherein the receiver lens module includes a plurality of lens modules with fixed focal lengths, each lens module including at least one concave lens and at least one convex lens, the lens modules being switched according to a detection range to modulate a size of field of view.

6. The LiDAR system according to claim 1, wherein the laser beam splitter module includes the diffractive optical element and a plurality of collimation lens assemblies with fixed focal lengths, the collimation lens assemblies being switched according to a detection range to modulate a range of field of image.

7. The LiDAR system according to claim 1, wherein the laser beam splitter module includes the diffractive optical element and a collimation lens assembly with an adjustable focal length, the collimation lens assembly being switched according to a detection range to modulate a range of field of image.

8. The LiDAR system according to claim 6, wherein the diffractive optical element diffracts the laser light into the diffractive lights, the collimation lens assembly is placed at a front of the diffractive optical element, and a mirror surface of the collimation lens assembly is perpendicular to an incident direction of the laser light to converge the diffractive lights to be substantially parallel to each other.

9. The LiDAR system according to claim 7, wherein the diffractive optical element diffracts the laser light into the diffractive lights, the collimation lens assembly is placed at a front of the diffractive optical element, and a mirror surface of the collimation lens assembly is perpendicular to an incident direction of the laser light to converge the diffractive lights to be substantially parallel to each other.

10. The LiDAR system according to claim 6, further including a concave mirror, the diffractive optical element diffracts the laser light into the diffractive lights, the concave mirror collects the diffractive lights, and the collimation lens assembly is placed at a front of the concave mirror to converge the diffractive lights to be substantially parallel to each other.

11. The LiDAR system according to claim 7, further including a concave mirror, the diffractive optical element diffracts the laser light into the diffractive lights, the concave mirror collects the diffractive lights, and the collimation lens assembly is placed at a front of the concave mirror to converge the diffractive lights to be substantially parallel to each other.

12. The LiDAR system according to claim 1, wherein the sensor shutter time and the reset time are determined according to a detection range.

13. The LiDAR system according to claim 11, further including a start time and an end time, the microcontroller controls the receiver to turn on between the start time and the end time within each cycle time, and to turn off during the remaining time;
the start time is determined according to a lower limit of the detection range; and
the end time is determined according to an upper limit of the detection range.

14. A resolution improvement method of the LiDAR system according to claim 1, the method comprising:
setting the diffractive optical element as a movable element with a function of rotation and/or reciprocating movement;
under conditions of a plurality of rotation angles or reciprocating positions, obtaining a plurality of subframes of environmental images;
each of the reflective light signals at each pixel of the environmental images representing a sub-distance value, a plurality of sub-distance values in each environmental image of a subframe constituting a three-dimensional image with depth information; and
after eliminating abnormal subframes, fusing the environmental images of the remaining subframes, if a pixel has a plurality of sub-distance values, taking an average or selecting one, if the pixel has only one sub-distance value, selecting the sub-distance value, if the pixel has no sub-distance value, selecting a maximum value within a detection range, and calculating the final distance value of the three-dimensional image of the frame.
